(19) United States
(12) Patent Application Publication
(10) Pub. No.: US 2025/0187640 A1
(43) Pub. Date: Jun. 12, 2025

(54) A HYBRID METHOD FOR CONTROLLING A RAILWAY SYSTEM AND AN APPARATUS THEREFOR

(71) Applicant: Technological Resources Pty. Ltd, Melbourne (AU)

(72) Inventor: William Jones, Melbourne (AU)

(21) Appl. No.: 18/685,978

(22) PCT Filed: Aug. 24, 2022
(86) PCT No.: PCT/AU2022/050982

§ 371 Date: Feb. 23, 2024

(30) Foreign Application Priority Data
Aug. 24, 2021 (AU) 2021902689

(51) Int. Cl. B61L 27/16; B61L 27/40; B61L 27/60

(52) U.S. Cl. CPC B61L 27/16; B61L 27/40; B61L 27/60; B61L 2201/00

(57) ABSTRACT

A method is provided for operating a transport network, for example a rail freight network including receiving a state report (or “snapshot”) of the transport network including positions of the vehicles and states of the network control apparatuses via the data communications network. A plurality of computer simulations of the transport network are run with reference to the state report. The computer simulations generate a number of feasible timetables and subsequently one of them is selected as an optimal feasible timetable, being a timetable that best satisfies demands for load at terminals of the network. Each of the plurality of computer simulations involves moving vehicle agents corresponding to the vehicles over a graph of the transport network according to a vehicle movement procedure that is configured to avoid gridlocking. The computer simulations are also run according to an optimal destination selection method which is configured to optimise vehicle agent journeys to meet the demand for the loads at locations in the transport network. Each of the plurality of computer simulations is made with varied weightings in respect of optimisation factors in the optimal destination selection method to thereby vary each of the number of feasible timetables. The method includes identifying an optimal timetable from the number of feasible timetables and issuing controls to the vehicles and network control apparatus via the data communications network to control movement of the vehicles across the transport network in accordance with the optimal timetable.

### RELATED APPLICATIONS

This application claims priority from Australian patent application No. 2021902689, filed 24 Aug. 2021, the content of which is hereby incorporated herein in its entirety.

### TECHNICAL FIELD

The present invention concerns methods and apparatus that implement a technical solution to the problem of operating railways in order to determine train destinations across a rail network and generate a feasible timetable that satisfies operational needs whilst avoiding deadlocks or “gridlocks”.

### BACKGROUND ART

Any references to methods, apparatus or documents of the prior art are not to be taken as constituting any evidence or admission that they formed, or form part of the common general knowledge.

Railway systems comprise rail networks that include interconnected blocks of rails and rolling stock such as locomotives and carriages that ride along the rails. For example, FIG. 1 is a side view of a train 1, comprised of a locomotive 5 that pulls carriages 7, travelling over rails 3. FIG. 2 indicates various internal assemblies of locomotive 5 of train 1.

FIG. 3 provides side views of trains 1a, . . . , 1n in a rail network 21 comprised of rails 3.

The network 21 includes network devices for controlling the paths of trains over the rails and for causing trains to stop and proceed at and from designated positions or “stations” throughout the rail network. Examples of the network devices include visual display signals 9a, 9b and switches 10a, 10b, for connecting one block of rail with either of two (or more) other blocks of rails, for example to divert train 1a to siding 23. The rail network 21 also includes a data communications system 29 having a data network 31 for transmitting position updates of trains to a central rail network controller 27 and for distributing timetabling data and/or commands for use in controlling the signal indicators 9a, 9b and switches 10a, 10b and thus the timing of trains along the rails and the paths taken by the trains. The data communications system 29 includes suitable radio infrastructure including terrestrial radio stations 14 and satellite stations 16.

Train 1a is shown in FIG. 3 dwelling at siding 23 of the network 21 and waiting for signal 9a to change state from “halt” to “proceed” under command from central controller 27. Whilst train 1a waits in the siding 23 the main line 25 is clear for another train 1b to pass therealong.

Upon the signal 9a changing state to “proceed” a person operating the locomotive 5 will manipulate control system 11 (FIG. 2) to send suitable signals to the train's propulsion system 13 to propel the train via its engine, transmission and wheels, along the rails 3.

Autonomous trains, which do not necessarily have a human driver are also known and in that case the control system 11 is arranged to detect “halt” and “proceed” signals from central rail network controller 27, for example via radio communications system 15 and coupled antenna 17. As train 1 proceeds along rails 3 it tracks its position via position tracker 19 (which is for example a geographical positioning system or Global Satellite Navigation System (GNSS)) and relays that position to the remote central controller across the data communications system 29. Alternatively, train position may be tracked by circuits in the tracks 3 that are arranged to determine the presence of a train and relay that information to the central rail network controller 27.

It will be realized that the particular timetabling of the journeys of trains along their allocated paths for each journey is important. Typically, a timetable is intended to achieve a particular objective, for example to minimize the amount of time that a train, such as train 1a must wait for another train, such as train 1b, to be able to pass safely and to avoid deadlocks occurring.

Unlike passenger services, freight rail typically does not follow a fixed timetable. In the case of railway networks that service mines, train movements are timetabled in response to demand which can fluctuate depending on the volume and quality of material currently being produced at each mine site and the requirements at the ports.

A train timetable is a specification of where each train should be located at any moment in time over the time spanned by the train timetable. Train dispatchers work with train timetables which are in a format similar to that of the stringline plot shown in FIG. 4. The movement of the trains is regulated by network control apparatus such as block signals and track switches. Block signals indicate to a train the speed it should travel at in the block section (a discrete section of track which can facilitate one train at a time) it currently occupies. Block sections are typically delimited by a unique pair of block signals at either end, which use coloured light to emit a signal which trains respond to following standardised response rules. The signals typically come in three colors: green, yellow and red. Typically a green signal means a train can travel at full speed, a yellow signal means a train must travel slowly (usually in preparation for a stop), and a red signal means a train must stop in its current block. It is still quite common for humans working in the network controller 27 to construct stringline plots, either entirely manually or with the help of computerized tools for timetabling trains across the railway network. Humans tend to err on the side of caution so that trains may be sided for longer than necessary. Furthermore, constructing a stringline graph for a large railway network with many trains is very demanding and mistakes can occur. It is not a trivial task to create a reasonably efficient train timetable, let alone an optimal one. In fact, creating an optimal train timetable is an NP-Hard problem.

In recent years optimization methods have been used to assist in finding feasible timetabling solutions. However, it has been found that the computational demands for solving the optimization problem for large railway networks with many trains can result in the computer time becoming infeasibly long, even with use of high-speed computer systems.

It is an object of the present invention to provide a method and apparatus for assisting in the timetabling of trains over a rail network that addresses at least one of the problems of the prior art or which is at least a commercially attractive alternative to hitherto known methods and apparatus of the prior art.

### SUMMARY OF THE INVENTION

According to a first aspect of the present invention there is provided a method for operating a transport network comprised of a plurality of nodes interconnected by a number of links and including vehicles located on the links and nodes, the vehicles being for transporting loads between nodes of the transport network, the method comprising:
establishing communications with vehicles and network control apparatus of the transport network over a data communications network;
subsequent to establishing the communications, receiving a state report (or “snapshot”) of the transport network including positions of the vehicles and states of the network control apparatuses via the data communications network;
running a plurality of computer simulations of the transport network with reference to the state report for generating a number of feasible timetables, each of the plurality of computer simulations comprising:
   moving vehicle agents corresponding to the vehicles over a graph of the transport network according to a vehicle movement procedure configured to avoid gridlocking, and according to an optimal destination selection method configured to optimise vehicle agent journeys to meet demand for the loads at locations in the transport network,
   wherein each of the plurality of computer simulations is made with varied weightings in respect of optimisation factors in the optimal destination selection method to thereby vary each of the number of feasible timetables;
identifying an optimal timetable from the number of feasible timetables; and
issuing controls to the vehicles and network control apparatus via the data communications network to control movement of the vehicles across the transport network in accordance with the optimal timetable.

In an embodiment the method includes, determining a set of constraints bounding each of the vehicle agents based on the graph.

In an embodiment the state report indicates the positions of the vehicles on the nodes and links of the transport network at a current time.

In an embodiment the vehicle movement procedure includes:
determining values in a current status data structure assembly stored in an electronic data storage assembly.

In an embodiment the current status data structure assembly stores:
node-vehicle-occupancy_reservation data (matrix E), link-vehicle-occupancy_reservation data (matrix F), node-vehicle-direction data (matrix C), link-vehicle-direction data (matrix D).

In an embodiment the graph includes slots defining vehicle hosting capacities of the nodes and the links including one or more passing places for vehicles to pass each other.

In an embodiment running each of the plurality of computer simulations includes associating vehicle journey information, including a destination, with a corresponding vehicle agent.

In an embodiment the vehicle movement procedure includes:
for each vehicle agent waiting at one of the passing places in the graph
   setting a next vehicle agent to be a current vehicle agent,
   making a copy of the current status data structure assembly for the current vehicle agent;
   updating the copy of the current status data structure assembly to incorporate reservations of nodes and links necessary for the current vehicle agent to proceed on a next leg of a journey defined in the vehicle agent's vehicle journey information to thereby form an updated vehicle-specific status data structure assembly.

In an embodiment the vehicle movement procedure includes:
for each vehicle agent, testing the updated vehicle-specific status data structure assembly to ensure that vehicle agents movements comply with a set of constraints bounding individual vehicle agents based on the graph.

In an embodiment the vehicle movement procedure includes:
upon the updated vehicle-specific status data structure assembly passing the testing, setting the current status data structure assembly to equal the updated vehicle-specific status data structure assembly and issuing a move instruction to the vehicle corresponding to the current vehicle agent.

In an embodiment the method includes, upon a vehicle agent reaching its destination, assigning it a new destination.

In an embodiment the method includes, successively setting each vehicle agent waiting at one of the passing places in the graph to be a current vehicle agent until all vehicle agents have reached their destination.

In an embodiment observing interactions of vehicle agents within constraints of the graph model to derive a feasible timetable for the vehicles therefrom includes producing the feasible timetables based on each of the move instructions issued to the vehicle agents.

In an embodiment the issuing the controls to the vehicles and network control apparatus to control movement of the vehicles across the transport network in accordance with the feasible timetable specifies movements for all vehicles without risk of gridlocking.

In an embodiment the vehicle movement procedure comprises an extended First Come First Served (eFCFS) heuristic that requires vehicle agents to reserve links up to a next available passing point before proceeding.

In an embodiment assigning of a new destination to a vehicle agent is made using a high score methodology.

In an embodiment the high score methodology generates a total score vector.

In an embodiment the method includes, specifying a demand quantity at each destination over a forthcoming time period.

In an embodiment the demand quantity at each destination over the forthcoming time period comprises a demand vector (\vec{δ}).

In an embodiment the total score vector vector (\vec{R}) is a weighted sum of the score values of a number of metrics.

In an embodiment the metrics include a first metric, which ranks destination priority (highest to lowest), in terms of the number of vehicles required at each destination.

In an embodiment the metrics include a second metric, which ranks destination options in terms of traffic density (lowest to highest) on a route of the vehicle agent.

In an embodiment the metrics include a third metric, which ranks destinations based on an estimate of how long the vehicle would wait in a queue to be loaded (lowest to highest).

In an embodiment the current status data structure assembly comprises:
a n by m matrix E storing the node-vehicle-occupancy_reservation data wherein,
   if Eᵢⱼ=1, then one slot of node i is either currently occupied by or reserved for vehicle j, whereas
   if Eᵢⱼ=0 then node i is not currently occupied by or reserved for vehicle j.

In an embodiment the current status data structure assembly comprises:
a l by m matrix F storing the link-vehicle-occupancy_reservation data, wherein
   if Fᵢⱼ=1, then one slot of link i is either currently occupied by or reserved for vehicle j, whereas if Fᵢⱼ=0, otherwise;

In an embodiment the current status data structure assembly comprises:
a n by m matrix C storing the node-vehicle-direction data wherein,
   if Cᵢⱼ=1, then one slot of node i is either currently occupied by or reserved for vehicle j which is travelling north,
   if Cᵢⱼ=−1, then one slot of node i is either currently occupied by or reserved for vehicle j which is travelling south,
   if Cᵢⱼ=0 then node i is not currently occupied by or reserved for vehicle j.

In an embodiment the current status data structure assembly comprises:
a l by m matrix D storing the link-vehicle-direction data with entries Dᵢⱼ∈{−1, 0, 1}, where positive and negative entries equal north, south travel directions respectively.

In an embodiment the eFCFS heuristic initially generates C, D, E and F and then iterates through vehicle agents currently waiting at a passing place, in a random order, to identify which vehicle agents can safely move and which must continue to wait.

In an embodiment for each vehicle in turn, a copy of C, D, E and F are made and updated to \tilde{C}, \tilde{D}, \tilde{E} and \tilde{F}, which incorporate reservations of nodes and links necessary for a vehicle agent to proceed on the next leg of its journey up to its next passing point.

In an embodiment the method includes, subjecting \tilde{C}, \tilde{D}, \tilde{E} and \tilde{F}, to a series of tests to ensure that vehicle agents are not overtaking each other.

In an embodiment the subjecting \tilde{C}, \tilde{D}, \tilde{E} and \tilde{F}, to a series of tests to ensure that vehicle agents are not overtaking each other comprises testing that each of the following three conditions hold:

$${\sum }_{j , ∀ i ∈ N} {\tilde{E}}_{i , j} \leq {N}_{i} and {\sum }_{j , ∀ i ∈ L} {\tilde{F}}_{i , j} \leq {L}_{i}$$

$$- 1 \leq {\sum }_{j , ∀ i ∈ N} {\tilde{C}}_{i , j} \leq 1 and - 1 \leq {\sum }_{j , ∀ i ∈ L} {\tilde{D}}_{i , j} \leq 1$$

$${\sum }_{j , ∀ i ∈ N} {\tilde{C}}_{i , j}^{2} \leq 2$$

In an embodiment the method includes, if all tests pass, setting C, D, E and F to equal \tilde{C}, \tilde{D}, \tilde{E} and \tilde{F}.

In an embodiment the eFCFS heuristic is triggered each time a vehicle agent arrives at a node so that all of the vehicle agents are moved from passing place to passing place from their origin to their destination in a computer simulation of the plurality of computer simulations.

In an embodiment once a vehicle agent reaches its destination, it is loaded or unloaded in the computer simulation and a new destination is assigned to the vehicle agent.

In an embodiment if a vehicle agent is directed to a node that comprises a terminal agent that is at capacity then the vehicle agent queues outside of the termina agent at the closest available passing point node until capacity becomes available for it to enter the terminal agent.

In an embodiment the method includes, if a vehicle agent is at its destination, setting its corresponding i,j entry in C, D to 0.

In an embodiment the method includes, selecting the optimal destination for any vehicle, by implementing the high score methodology whereby a number of metrics are calculated returning vectors (each with dimensions ‘1’ by the number of possible destinations d) of score values \vec{W₁}, \vec{W₂}, \vec{W₃} with entries between 0 and 100 for each possible destination option.

In an embodiment the method includes, calculating a total score vector, \vec{R}, as,

$$\vec{R} = \vec{{W}_{1}} x + \vec{{W}_{2}} y + \vec{{W}_{3}} z$$

where x, y and z are weightings configured such that x+y+z=1.

In an embodiment the three metrics comprise \vec{W₁} \vec{W₂} and \vec{W₃} where

$$\vec{{W}_{1}} = \vec{δ} / {δ}_{max} * 100$$

$$\vec{{W}_{2}} = 1 / ( ( ( E {A}^{T} N / max ( E {A}^{T} N ) + ( F {B}^{T} L ) / max ( F {B}^{T} L ) ) ) * 100 , and$$

$$\vec{{W}_{3}} = 1 / ( ( \vec{Q} - \vec{P} ) / max ( \vec{Q} - \vec{P} ) * 100 )$$

where \vec{δ} is the vector of the demand, A and B are route-node and route-link incidence matrices, \vec{Q} is a vector of estimated vehicle waiting times at a terminal agent and \vec{P} is a vector of the minimum travel time based on the shortest path link lengths for a vehicle to reach each destination option.

In an embodiment the method includes, after a vehicle agent completes unloading, recalculating \vec{R} a number of times throughout the vehicle agents' journey.

In an embodiment \vec{R} is recalculated at major junction nodes of the graph.

In an embodiment weightings x, y, z, are fixed for a period of one of the plurality of computer simulations.

In an embodiment the method includes, finding values of x, y, z that best satisfy the demands at each destination that are prescribed in the demand vector \vec{δ}.

In an embodiment X, Y, Z range from 0 to 1.

In an embodiment X, Y, Z define a parameter space, the parameter space being of dimensions [0,1]×[0,1]×[0,1] and the method includes varying the x, y, z values to adjust a value of the total score vector \vec{R}.

In an embodiment a discrete set of points is simulated as evenly distributed across a triangular cross section of the parameter space where x+y+z=1.

In an embodiment the simulation is repeated for each combination of x+y+z=1 over the plurality of simulations.

In an embodiment in each simulation of the plurality of simulations, each train visits the different destinations in a different order due to the total score vector, \vec{R}, generating a different result each time it is calculated.

In an embodiment the method includes, interrogating results of the plurality of simulations to identify which combination of x, y, z produce a best feasible timetable.

In an embodiment a determination is made of which combination of x, y, z has satisfied demand across the destinations so that a proportion of demand satisfied at each destination is most similar, whereby the x, y, z weighting values identified represent the best values to use

In an embodiment the method includes, generating a timetable for a next period based on current demands.

According to another aspect of the present invention there is provided a timetabling machine arranged operate a transport network comprised of a plurality of nodes interconnected by a number of links and including vehicles located on the links and nodes, the vehicles being for transporting loads between nodes of the transport network, the timetabling machine comprising:
a data communications port configured to establish communications with vehicles and network control apparatus of the transport network over a data communications network;
one or more electronic processors configured by instructions stored in an electronic memory accessible to said electronic processors, the instructions including:
instructions to receive a state report (or “snapshot”) of the transport network including positions of the vehicles and states of the network control apparatuses via the data communications port;
instructions configuring the one or more processors to implement a method as previously stated.

According to a further aspect of the present invention there is provided a timetabling machine arranged operate a transport network comprised of a plurality of nodes interconnected by a number of links and including vehicles located on the links and nodes, the vehicles being for transporting loads between nodes of the transport network, the timetabling machine comprising:
a data communications port configured to establish communications with vehicles and network control apparatus of the transport network over a data communications network;
one or more electronic processors configured by instructions stored in an electronic memory accessible to said electronic processors, the instructions including:
instructions to receive a state report (or “snapshot”) of the transport network including positions of the vehicles and states of the network control apparatuses via the data communications port;
instructions configuring the one or more processors to run a plurality of computer simulations of the transport network with reference to the state report to thereby generate a number of feasible timetables, including
   instructions for the one or more electronic processors to move vehicle agents corresponding to the vehicles over a graph of the transport network, stored in an electronic data storage assembly, according to a vehicle movement procedure configured to avoid gridlocking, and according to an optimal destination selection method configured to optimise vehicle agent journeys to meet demand for the loads at locations in the transport network,
   wherein instructions configuring the one or more processors to run a plurality of computer simulations include instructions configuring the one or more processors to run each of the plurality of computer simulations with varied weightings in respect of optimisation factors in the optimal destination selection method to thereby vary each of the number of feasible timetables;
instructions configuring the one or more electronic processors to identify an optimal timetable from the number of feasible timetables; and
instructions configuring the one or more electronic processors to operate the data communications port to issue controls to the vehicles and network control apparatus via the data communications network to control movement of the vehicles across the transport network in accordance with the optimal timetable.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts a train in use.

FIG. 2 depicts a train in use revealing internal assemblies of a locomotive of the train.

FIG. 3 is a block diagram a rail network in use.

FIG. 4 is an example of a stringline plot train timetable.

FIG. 5 is a block diagram of a railway system according to an embodiment of the present invention in use.

FIG. 5A is a plan view of a traffic control apparatus or “traffic controller” in the form of a switch for selectively directing a train along one of two paths, shown in a configuration for directing the train along a first path being a main line.

FIG. 5B is a plan view of the traffic control apparatus shown in a further configuration for directing the train along a second path being a siding.

FIG. 6 is a block diagram of a timetabling machine in the form of a specially programmed computational device being a computer server, shown in use.

FIG. 7 is a diagrammatic representation of a graph that is accessible to the timetabling machine, and which models a transport network such as the rail network of FIG. 3.

FIG. 8a is a train graph or “stringline” plotting movements of three vehicles M1, M2, M3 through the transport network of FIG. 7.

FIG. 8b is a graph of a triangular cross section of area [0,1]×[0,1]×[0,1] where x+y+z=1 wherein each point in the triangular cross section represents one complete timetable simulation of an ensemble of simulations, producing a feasible timetable with different x, y, z weightings for each of three different optimal destination selection metrics (W1, W2, W3).

FIG. 9a is a graph indicating number of instances of demand not being satisfied in the ensemble of simulations of FIG. 8b.

FIG. 9b is a graph indicating the extent to which demand was not satisfied in the ensemble of simulations of FIG. 8b for any destination.

FIG. 10 is a flowchart of a method according to an embodiment herein for controlling a transport system.

FIG. 11 is a diagram showing how verbatim application of a FCFS (First Come First Serve) scheduling heuristic can result in an infeasible solution.

FIG. 12 is a diagram illustrating direction-based slot assignment.

FIG. 13 is a diagram illustrating Case 1 of a proof that an extended First Come First Serve (eFCFS) scheduling heuristic will always produce feasible schedules.

FIG. 14 is a diagram illustrating Case 2 of a proof that an extended First Come First Serve (eFCFS) scheduling heuristic will always produce feasible schedules.

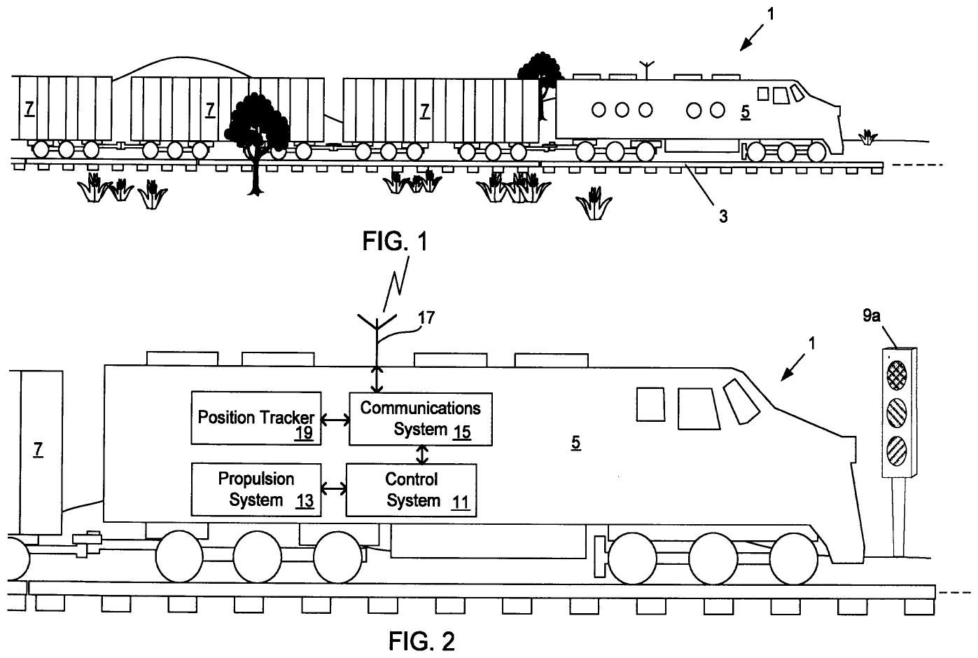

### DETAILED DESCRIPTION OF PREFERRED EMBODIMENTS

### 1. Overview and Timetabling Machine

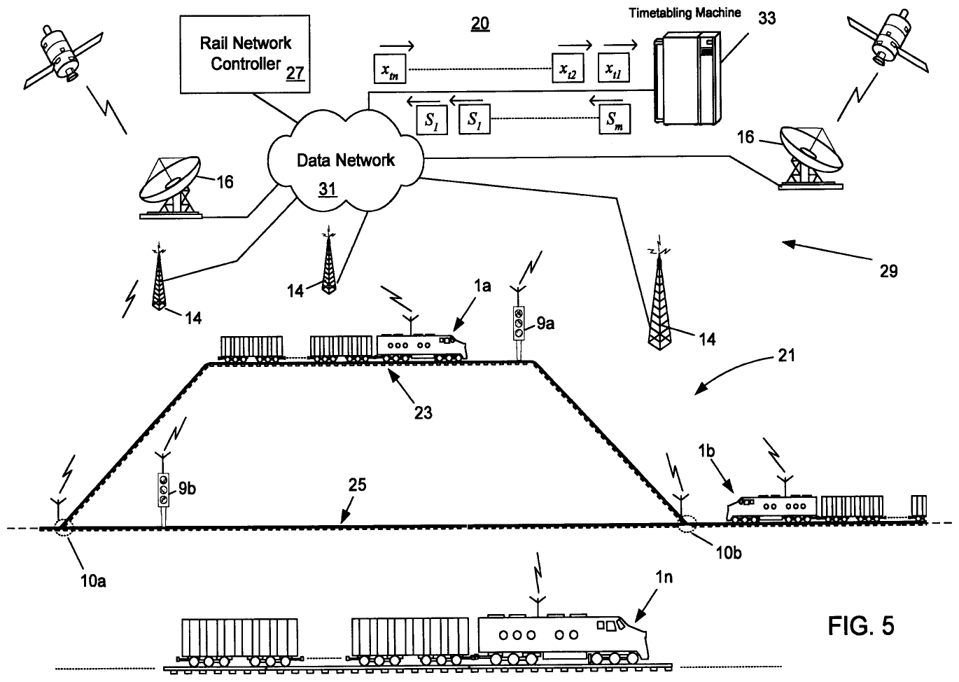

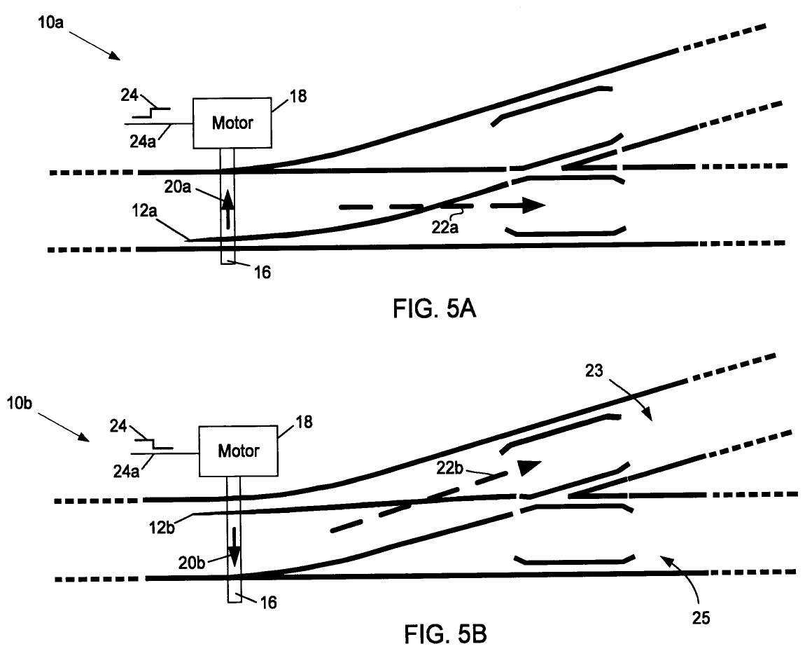

Referring now to FIG. 5 there is depicted, in one embodiment, a railway system 20.

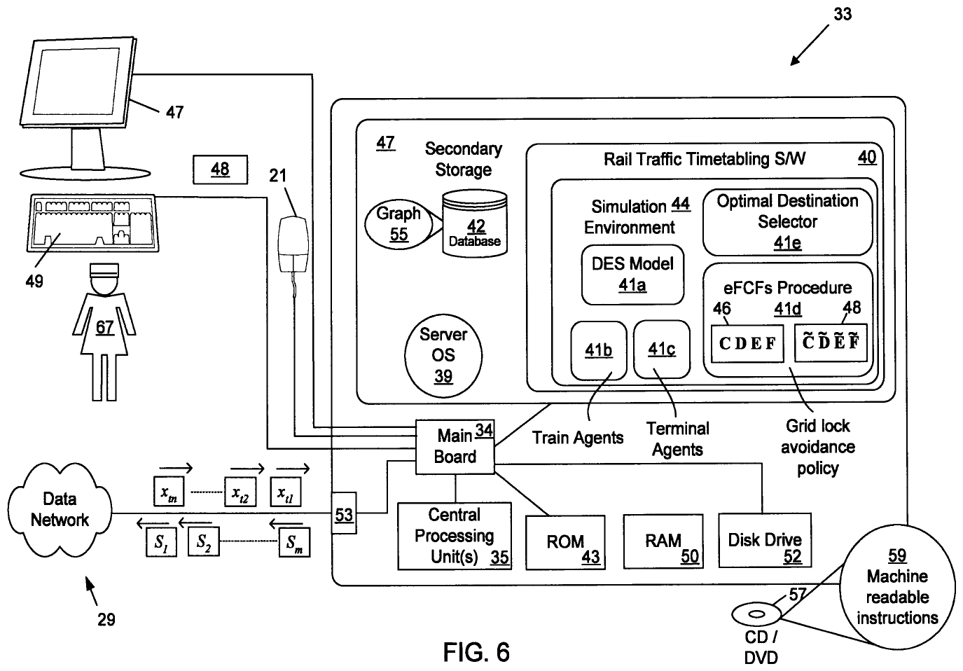

The railway system 20 includes a transport network in the form of railway network 21 that includes a plurality of blocks of rails such as main line 25 and siding 23 and a number of trains 1a, . . . , 1n located on the blocks of rails. The network also includes one or more positioning assemblies, such as position tracker 19 (FIG. 2) for determining positions of each train. Railway system 20 includes a data communications system 29, including data network 31, for transmitting state data, such as state data reports xt₁, . . . , xtₙ defining states of the railway network 21 at respective times or as they are sometimes called “snapshots” of the status of the railway network. Railway system 20 also includes a timetabling machine 33 that is in communication with the data communications system 29 for receiving the state data. As shown in FIG. 6, timetabling machine 33 includes a graph 55 which represents the topology of the railway network 21. As will be discussed, the graph 55 (FIG. 6) is stored in an electronic data source in the form of database 42. The graph 55 defines features of the network 21 including nodes and edges which interconnect the nodes and which correspond to features of the railway network including stations, sidings and tracks. The graph also includes information about the capacity or number of “slots” of each node and link being the number of trains that each node and link is able to accommodate. As will be discussed in more detail shortly, the timetabling machine 33 includes one or more processors 35 and an electronic memory 47 in communication with the processors 35.

As previously mentioned, according to a preferred embodiment of the present invention a specially programmed computational device in the form of timetabling machine 33 is provided that is in data communication with the Rail Network Controller 27 via data communications system 29 including data network 31. As will be discussed, timetabling machine 33 accesses a graph 55, comprised of nodes interconnected by edges, that models the railway network.

FIG. 5A is a plan view of a railway network traffic controller in the form of the switch 10a. Switch 10a includes point blades 12a, 12b which are tied by throw bar 16. The throw bar 16 is coupled to motor 18 for translating the throw bar 16 back and forth as indicated by arrows 20a, 20b in order to point blades 12a, 12b simultaneously from the position shown in FIG. 5A to the position shown in FIG. 5B. In the position shown in FIG. 5A the point blades 12a, 12b directs a train along the main line 25 as indicated by arrow 22a. Alternatively, in the position shown in FIG. 5B the switch 10A directs the train along the siding 23 as indicated by arrow 22b.

The motor 18 is electrically coupled to the data network 31 of data communications system 29 and so the switch 10a can be remotely operated by controls in the form of control signals 24 that are ultimately derived from timetabling information generated by timetabling machine 33. Similarly, signal lights such as lights 9a, 9b are also remotely controllable. Consequently, by using traffic controllers of the railway network, such as switches 10a, 10b and signal lights 9a, 9b, and also be sending commands to the trains, train timetables generated by the timetabling machine 33 are able to be implemented in the railway network.

FIG. 6 comprises a block diagram of one embodiment of the timetabling machine 33. In this embodiment the timetabling machine 33 includes a main board 34 which includes circuitry for powering and interfacing to one or more onboard microprocessors 35.

The main board 34 acts as an interface between microprocessors (CPUs) 35 and secondary memory 47. The secondary memory 47 may comprise one or more optical or magnetic, or solid state, drives. The secondary memory 47 stores instructions for an operating system 39. The main board 34 also communicates with random access memory (RAM) 50 and read only memory (ROM) 43. The ROM 43 typically stores instructions for a startup routine, such as a Basic Input Output System (BIOS) or Unified Extended Firmware Interface (UEFI) which the microprocessor 35 accesses upon start up and which preps the microprocessor 5 for loading of the operating system 39.

The main board 34 also an integrated graphics adapter for driving display 47. The main board 3 will typically include a communications adapter, for example a LAN adaptor or a modem 53, that places the timetabling machine 33 in data communication with data network 31 of data communications system 29.

An operator 67 of timetabling machine 33 interfaces with it by means of keyboard 49, mouse 21 and display 47.

The operator 67 may operate the operating system 39 to load software product 40. The software product 40 may be provided as tangible, non-transitory, machine-readable instructions 59 borne upon a computer readable media such as optical disk 57. Alternatively, it might also be downloaded via port 53.

The secondary storage 47, is typically implemented by a magnetic or solid-state data drive and stores the operating system, for example Microsoft Windows Server, and Linux Ubuntu Server are two examples of such an operating system.

The secondary storage 47 also includes a server-side rail traffic timetabling software product 40 according to a preferred embodiment of the present invention which implements a database 42 that is also stored in the secondary storage 47, or at another location accessible to the timetabling machine 33. The database 42 stores the graph 55 that is used, in conjunction with the system state data xt₁, . . . , xtₙ by processor 35 under control of software 40 to implement a method for determining rail traffic journeys across the railway network. The database 42 stores the railway network graph 55 including data defining edges interconnected by nodes comprising a graph.

During operation of the timetabling machine 33 the one or more CPUs 35 load the operating system 39 and then load the software 40.

The timetabling machine 33 receives data, for example the network state information xt₁, . . . , xtₙ about the state of the railway network from the data network 31, to which the timetabling machine 33 is connected by means of its data port 53.

In use the timetabling machine 33 is operated by an administrator 67 who is able to log into the timetabling machine interface either directly using mouse 21, keyboard, 49 and display 47, or more usually remotely across data communications system 29. Administrator 67 is able to monitor activity logs and perform various housekeeping functions from time to time in order to keep the timetabling machine 33 operating in an optimal fashion.

It will be realized that the discrete server machine that implements timetabling machine 33 in the exemplary embodiment of FIG. 6 is simply one example of a computing environment for executing software 40. Other suitable environments are also possible, for example timetabling machine 33 could be implemented in a suitably configured virtual machine incorporating Rail Traffic Timetabling Software 40 in a cloud computing environment.

The timetabling machine 33 receives time separated network state data in the form of state data reports xt₁, . . . , xtₙ or “snapshots” from the rail network controller 27 via the data communications system 29. Timetabling machine 33 is configured by instructions comprising a software product 41 that it runs to implement a method for processing the network state snapshots to generate time separated timetables S₁, . . . , Sₘ for trains running on the network 21. The rail network controller 27 uses the time-separated timetables S₁, . . . , Sₘ to operate traffic controllers such as switches, e.g. switches 10a, 10b and signaling apparatus, e.g. signal lights 9a, 9b of the network in order to dynamically manage rail traffic across the network in accordance with the timetables S₁, . . . , Sₘ.

The electronic memory contains instructions for the processors 35 to effect a number of tasks. The processors implement a simulation environment 44 in which they run a simulation of the transport network, e.g. rail network 21. The simulation comprises vehicle agents 41b moving over graph 55 of the transport network 21. Vehicle agents, for example train agents, or truck agents, are simulations of physical vehicles, such as trains, or trucks, for the purpose of arriving at possible feasible timetables. The vehicle agents are simulated in a simulation environment produced by the timetabling machine and thus the timetabling machine able to run many simulations quickly to arrive at a set of feasible timetables.

The vehicle agents 41b move over graph 44 of the transport network 21 according to a vehicle movement procedure 41d, which is an extended First Come First Serve (eFCFS procedure) and according to an optimal destination selection method 41e.

The optimal destination selection method 41e is configured to best satisfy demand for material transported by the vehicles over the transport network. The processors, configured by the Rail Traffic Timetabling Software 41 observe interactions of the vehicle agents 41b within constraints of the graph model 55 to derive a feasible timetable for the vehicles, e.g. trains 1a, . . . , 1n for controlling movement of the trains. For example the controls may be transmitted as timetables S₁, . . . , Sₘ to the Rail Network Controller 27 where they are for example displayed as stringlines for human operators to then issue control signals to the trains and network traffic controllers such as switches 10a, 10b and signal lights 9a, 9b. Alternatively, or in addition, control signals 24 (FIGS. 5A, 5B) based on the controls generated by the timetabling machine 33 may be applied to the network traffic controllers, e.g. switches 10a, 10b via control line 24a which is coupled to the data network 31.

The method that is programmed as instructions comprising the rail traffic timetabling software 40 will now be explained.

### 1. Hybrid Simulation and Heuristics Design

An ‘extended first come first served’ (eFCFS) heuristic (Nathan-Roberts, 2019) is employed to govern train movements between given origins and destinations. Relevant portions of the heuristic are reproduced in the Appendix at the end of this specification.

The entire Nathan-Roberts specification is set forth in the specification of Australian patent application No. 2021902689 filed 24 Aug. 2021 and is hereby incorporated by reference in its entirety. The method takes into account multiple vehicle cycles. A single cycle is defined to be: leave unloading destination, travel to loading destination, load, return to unloading destination and unload. After loading/unloading, trains must be assigned a new destination. In an embodiment the method uses a ‘high score’ heuristic methodology, which is implemented by optimal destination selector 41e, for destination selection. By performing an ensemble of simulations incorporating the heuristic methods in simulation environment 44, the timetabling machine 33 is able to identify the optimal destinations for trains to visit and the order to do so.

### Network Graph Model

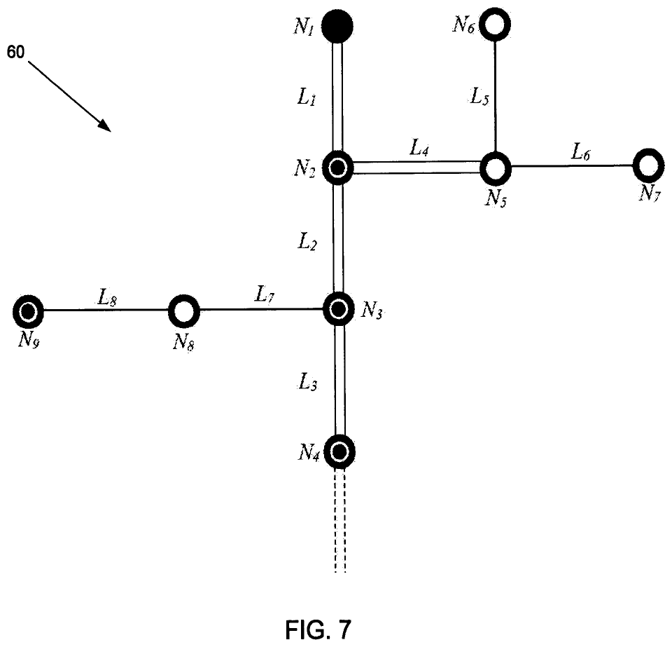

The detailed graph 55 models the railway network 21 as a network of n nodes and l links (track sections) as resources available to be occupied by m trains. Each node and link contains a designated number of slots s where one slot can host one train at any time. Hence, N and L define vectors of dimensions 1 by n, l respectively where each entry represents the capacity (number of slots available) of the corresponding i^{th} node or link. Link ‘lengths’ reflect the travel time for a train to transit that link. Nodes are simply modelled as points (i.e., travel time to transit a node is zero). FIG. 7 provides a simple illustration of a portion 60 of a typical graph network structure such as graph 55. In FIG. 7, N₁, N₆, N₇, N₉ are terminal nodes. For N₅, N₆, N₇, N₈ s=1. For N₂, N₃, N₄, N₉ s=2. For N₁ s=. For L₁, L₂, L₃, L₄ s=2. For L₅, L₆, L₇, L₈ s=1.

Timetabling machine 33 generates suitable data structures, such as arrays to implement an n by m and a l by m matrix, E and F respectively, to describe train locations in the network and the nodes and links they have reserved. If Eᵢⱼ=1, then one slot of node i is either currently occupied by or reserved for train j, whereas if Eᵢⱼ=0 then node i is not currently occupied by or reserved for train j. Similarly, if Fᵢⱼ=1, then one slot of link i is either currently occupied by or reserved for train j. If Fᵢⱼ=0, otherwise. Timetabling machine 33 uses two further matrices, C and D (n by m and l by m respectively), indicate trains direction of travel. If Cᵢⱼ=1, then one slot of node i is either currently occupied by or reserved for train j which is travelling north, if Cᵢⱼ=−1, then one slot of node i is either currently occupied by or reserved for train j which is travelling south. If Cᵢⱼ=0 then node i is not currently occupied by or reserved for train j. Similarly, D defines link travel direction with entries Dᵢⱼ∈{−1, 0, 1}, where positive and negative entries equal north, south travel directions respectively. Note, if at its destination, a train's corresponding i,j entry in C, D will be 0. The matrices C, D, E, F are stored in a current status data structure assembly 46 (FIG. 6). The matrices store data that may be referred to as follows:
Matrix E, stores “node-vehicle-occupancy_reservation” data,
Matrix F, stores “link-vehicle-occupancy_reservation” data,
Matrix C, stores “node-vehicle-direction” data,
Matrix D, stores “link-vehicle-direction” data.

### Hybrid Simulation Model

The Rail Traffic Timetabling software 40 comprises a hybrid Discrete-Event Simulation (DES) and Agent Based Modelling (ABM) model and was developed in the Python programming language using functionality from the SimPy (2020) library (https://simpy.readthedocs.io/_/downloads/en/3.0.12/pdf/retrieved 23/8/2021) The DES model 41a maps the status of the nodes and links of Graph 55 (i.e., occupied by a train or free), with reference to the snapshots xt1, . . . , xtm that it receives, with the mapping reflecting the time taken for a train to move between two nodes based on the link length. Trains and terminals are modelled as autonomous agents 41b, 41c. The DES model 41a in conjunction with the train autonomous agents 41b and the terminal autonomous agents 41c comprise the simulation environment 44 that is produced by timetabling machine 33 as it executes the instructions comprising the rail traffic timetabling software 40.

Train agents 41b store information relevant to their journey (i.e., destination, shortest path route to the destination, direction of travel) and are bound by the constraints of the DES model 41a and network topology contained in graph 55. Instructions for movements can be provided to train agents 41b within the simulation environment 44 and hence when the DES model 41a is run, trains can be observed in the simulation environment 44, moving from their current location to that instructed. By performing an ensemble of simulations incorporating the heuristic methods that will be described, the timetabling machine 33 identifies optimal destinations for trains to visit and the order to do so to thereby produce a timetable.

As previously mentioned, a subset of nodes in the network 21 are specified as terminal agents 41c (i.e., mine sites and ports). At terminals, trains are loaded or unloaded. This process is implemented by timetabling machine 33 as a delay drawn from a uniform distribution. Once loading/unloading is complete, train agents 41b are assigned a new destination (chosen via the method described in Section 3.4) in the simulation environment 44. Once a new destination is assigned, the train can depart the terminal. A train's prescribed destination should always be one of these terminals unless currently loading/unloading in which case simply ‘at destination’ is prescribed.

The DES model 41a defines a set of constraints bounding individual train agents 41b. No timetable is prescribed to the trains, just a destination. It is only through running the simulation (incorporating the eFCFS heuristic and optimal destination selection) and observing the interactions of trains within the constraints of the graph model 55 that train movements emerge and a feasible timetable can be generated.

eFCFS Heuristic Implementation

The eFCFS procedure 41d proposed by Nathan-Roberts (2019) defines a set of rules to govern train (or more generally “vehicle”) movements that will prevent them from gridlocking i.e., moving into a position where one or more trains would need to reverse. The eFCFS procedure 41d that is coded into Rail Traffic Timetabling Software 40 achieves this by requiring trains to reserve sections of track up to the next available passing point before proceeding. Rail traffic timetabling software 40 includes instructions for processor 35 to run the eFCFS procedure 41d repeatedly over time in order that a timetable can be generated as the stochastic simulation is run.

At any moment, the four matrices C, D, E and F (described above) can be generated. The eFCFS movement procedure 41d dictates that any trains may only stop at passing places i.e., nodes where s>1. Hence, any train occupying a link or a node with s=1 will reserve the nodes and links up to the next node in their route where s=2. These reservations are captured in the four matrices.

When triggered, the eFCFS procedure 41d generates C, D, E and F as above, then iterates through the train agents currently waiting at a passing place, in a random order, to identify which train agents can safely move and which must continue to wait. For each of the train agents 41b in turn, a copy of C, D, E and F are made and updated to \tilde{C}, \tilde{D}, \tilde{E} and \tilde{F}, which is stored in a vehicle-specific status data structure assembly 48 (FIG. 6) and which incorporate the necessary reservations of nodes and links, which that train agent would need to make to proceed on the next leg of its journey
i.e., \tilde{C}ᵢⱼ=1, \tilde{D}ᵢⱼ=1
(or \tilde{C}ᵢⱼ=−1, \tilde{D}ᵢⱼ=−1 if travelling south), \tilde{E}ᵢⱼ=1 and \tilde{F}ᵢⱼ=1 for all i,j positions in C, D, E and F that correspond to nodes or links in the train agent's route up to its next passing point. C, D, E and F, are then subject to a series of tests;

$${\sum }_{j , ∀ i ∈ N} {\tilde{E}}_{i , j} \leq {N}_{i} and {\sum }_{j , ∀ i ∈ L} {\tilde{F}}_{i , j} \leq {L}_{i} \qquad ( 1 )$$

$$- 1 \leq {\sum }_{j , ∀ i ∈ N} {\tilde{C}}_{i , j} \leq 1 and - 1 \leq {\sum }_{j , ∀ i ∈ L} {\tilde{D}}_{i , j} \leq 1 \qquad ( 2 )$$

$${\sum }_{j , ∀ i ∈ N} {\tilde{C}}_{i , j}^{2} \leq 2 \qquad ( 3 )$$

Simply, in (1) the rows of matrices E and F are summed to create single vectors of length n or l and test that each entry of those vectors is less than or equal to the corresponding entry of N and L respectively (i.e., the number of train agents is not greater than the number of slots available on nodes/links of graph 55). Further, each entry of C and D are asserted to be bound by defined integers as (2) and (3). Essentially, tests (1) to (3) ensure that train agents are not overtaking each other, double capacity nodes only allow train agents travelling in opposite directions to pass.

If all tests pass, C, D, E and F are set equal to \tilde{C}, \tilde{D}, \tilde{E} and \tilde{F} and, further, a move instruction for the corresponding train agent will be generated in the simulation environment. If any of the tests fail, the changes are not incorporated into the original matrices and no move instruction issued for the train agent. Accordingly, upon the matrices stored in the updated vehicle-specific status data structure assembly 48 passing the testing, the current status data structure assembly 46 is set to equal the updated vehicle-specific status data structure assembly 48 and a move instruction is then issued to the vehicle, e.g., one of trains 1a, . . . , 1n via data communications system 29, corresponding to the current vehicle agent.

Pass or fail, the method is then repeated for the next train agent in the list of train agents waiting at a passing point. The eFCFS procedure 41d is triggered each time a train agent arrives at a node so that all of the train agents 41b are moved step by step (i.e., passing place to passing place), from their origin to the given destination (i.e., load/unload terminal) in the simulation environment. Once a train agent reaches its destination, it will be loaded or unloaded and a new destination will be assigned, as will be discussed later. If a train agent is directed to one of the terminal agents 41c that is at capacity (i.e., with other train agents loading/unloading) it will queue outside of the terminal agent at the closest available passing point node (and additional train agents headed for the same destination will queue behind it) until capacity becomes available for it to enter the terminal. Running the simulation incorporating this heuristic method creates the necessary instructions in the simulation environment 44 to move all train agents 41b, without risk of gridlocking, such that ultimately a feasible timetable can be produced and train graph plotted, however, poor choice of destinations may result in slow traffic flow.

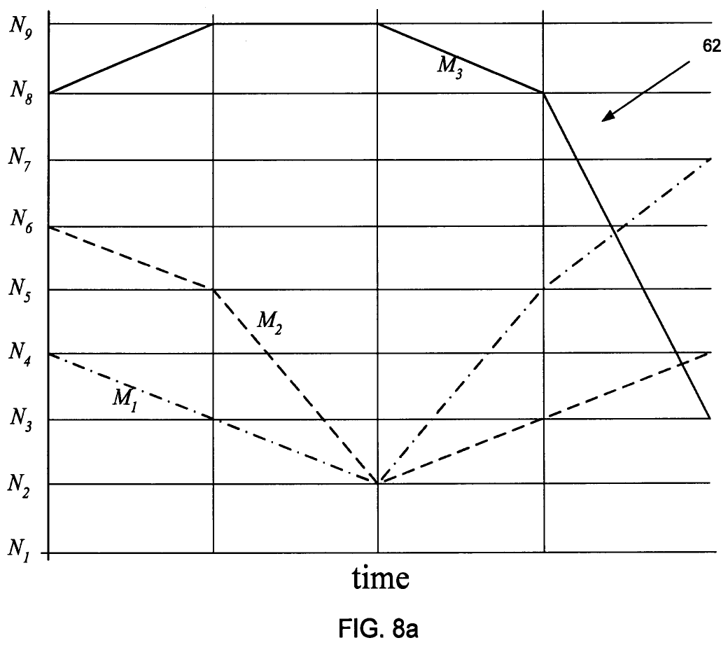

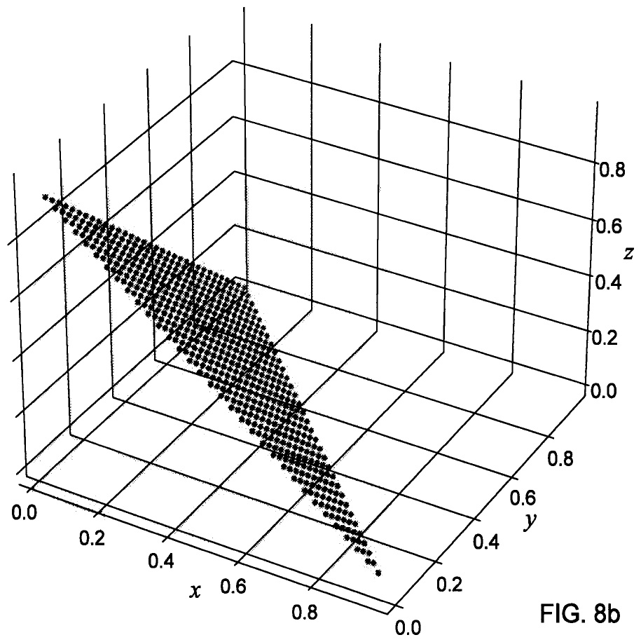

FIG. 8a illustrates a train movement graph 62 plotting train agents' movements through the example network shown in graph portion 60 of FIG. 7. In, train movement graph 62, train agents, M₁ and M₂ move from N₄ and N₆ to N₇ and N₄ respectively. They pass each other at N₂, where s=2. M₃ is shown moving from N₈ to terminal node N₉. It stays at N₉ for a period of time while loading. Once loaded it is assigned a new destination and returns into the network proceeding to that new destination via N₈ and N₃.

### Optimal Destination Selection Calculation

To select the optimal destination for any train agent, a ‘high score’ methodology is implemented whereby three metrics are calculated returning vectors (each with dimensions ‘1’ by the number of possible destinations d) of score values \vec{W₁}, \vec{W₂}, \vec{W₃} with entries between 0 and 100 for each possible destination option. Subsequently, a total score vector, \vec{R}, can be calculated as,

$$\vec{R} = \vec{{W}_{1}} x + \vec{{W}_{2}} y + \vec{{W}_{3}} z \qquad ( 4 )$$

where x, y and z are scalar weightings configured such that x+y+z=1. Hence, each component Rᵢ i=1, . . . d of R will have a value such that 0≤Rᵢ≤100. (FIG. 8b illustrates x+y+z=1, just how the individual values may be set will be explained subsequently).

The three metrics reflect factors which would influence the destination selection if chosen manually by an operator.

$$\vec{{W}_{1}} = \vec{δ} / {δ}_{max} * 100 \qquad ( 5 )$$

$$\vec{{W}_{2}} = 1 / ( ( ( E {A}^{T} N / max ( E {A}^{T} N ) + ( F {B}^{T} L ) / max ( F {B}^{T} L ) ) ) * 100 , and \qquad ( 6 )$$

$$\vec{{W}_{3}} = 1 / ( ( \vec{Q} - \vec{P} ) / max ( \vec{Q} - \vec{P} ) * 100 ) \qquad ( 7 )$$

where \vec{δ} is a vector of the demand i.e., number of train agents to be sent to each destination in the simulation environment 44 over the next period (say 48 hours), A and B are route-node and route-link incidence matrices (indicating the shortest path from a train agent's current location to destination), n by d and 1 by d respectively (i.e., Aᵢⱼ=1 if node i is used in route j, 0 otherwise and ^{T} denotes matrix transpose), \vec{Q} is a vector of estimated waiting times a train agent would queue for until a loading bay became available at the terminal (accounting for the time of any currently loading train agents and train agents waiting to load or on route to load at that terminal) and \vec{P} is a vector of the minimum travel time based on the shortest path link lengths for a train agent to reach each destination option.

In practice, the metrics reflect the network state as follows. \vec{W₁} effectively ranks the destination priority (highest to lowest), in terms of the number of train agents required at each destination. Further, \vec{W₂} ranks destination options in terms of the traffic density (lowest to highest) on the route (i.e., number of train agents using the links and nodes in the route divided by the total number of links and nodes in the route). Finally, \vec{W₃} ranks destinations based on an estimate of how long the train agent would wait in a queue to be loaded (lowest to highest). Hence, \vec{R} is a heuristically calculated ranking indicating the best (highest scoring) destination option at the time of calculation.

To ensure the destination selected remains the best choice for each train agent, additionally to first calculation immediately after a train agent completes unloading, \vec{R} is recalculated on several occasions throughout the train agent's journey and the destination revised if necessary. In the presently described embodiment, \vec{R} is recalculated at major junction nodes for example, N₂, N₃ and N₅ in FIG. 7. There is no point in recalculating \vec{R} at, e.g., N₈ as a train agent transiting this node has no option but to continue in the direction it is travelling. As an example, consider a train agent travelling north from N₃ towards N₆, when it reaches N₂\vec{R} is recalculated. Due to changes in network conditions, the calculation now suggests N₇ is a better choice, so the train agent's destination is updated. Note, at N₂ the options of destination for the train agent travelling north would be N₁, N₆ and N₇. Therefore, \vec{R} is calculated based on this reduced subset of possible destinations. In no circumstances would a train agent travelling north at N₂ have its destination revised such that it was redirected south, e.g., to N₉, as this is not feasible within the constraints of the graph 55 of network 21.

Weightings x, y, z, in (4), are fixed for the period simulated. In the simple example train movement graph 62, shown in FIG. 8a, M₃ may be assigned a different destination after loading at N₉ if x, y, z are weighted differently.

FIG. 8b illustrates a triangular cross section of area [0,1]×[0,1]×[0,1] where x+y+z=1. Each point represents one complete simulation (i.e., producing a feasible timetable) with different values of x, y, z weighting \vec{W₁}, \vec{W₂} and \vec{W₃} respectively, hence, resulting in different destination decisions (see (4)). Vectors X, Y, Z define the three dimensional area [0,1]×[0,1]×[0,1]. Any point within that area can be referred to by x, y, z. The sub set of points where x+y+z=1 defines a triangular cross section of the three dimensional area.

In a simulation of a large network (say 150+ nodes) with more train agents (say 50+) and terminals (say 10+) run for a long period (say 2 days), many train agents will reach their destination and be assigned new destination. Variation to x, y, z will impact \vec{R} each time it is calculate for each train agent and subsequently dramatically impact the resultant train movement graph produced. In a simulation of a large network (say 150+ nodes) with more train agents (say 50+) and terminal agents (say 10+) run for a long period (say 2 days), many train agents will reach their destination and be assigned new destination. Variation to x, y, z will impact \vec{R} each time it is calculate for each train agent. For any network and set of demands \vec{δ}, the optimal x, y, z weightings need to be determined to calculate \vec{R}.

### Ensemble Simulation Methodology

The above outlines how a single train movement graph (timetable) is constructed in the simulation environment 44 by the timetabling machine 33. However, it is desired to find the values of x, y, z in (4) that best satisfy the demands at each destination that are prescribed in \vec{δ}.

Consider X, Y, Z are vectors ranging from 0 to 1 in equal increments. They define the parameter space [0,1]×[0,1]×[0,1] and varying their relative values will adjust the outcome of (4). A discrete set of points is simulated as evenly distributed across the triangular cross section of this area where x+y+z=1 (see FIG. 8b). At the centre of this area x, y, z=⅓ and in any corner x or y or z=1 while the other two variables equal 0. The simulation method described above is repeated for each combination of x+y+z=1. Each simulation therefore produces a different timetable. In each case, each train agent may visit the different destinations in a different order due to the high score method (\vec{R} in (4)) generating a different result each time it is calculated because of the weightings x, y, z. Hence, for each simulation across the triangular cross section x+y+z=1 a different timetable can be produced.

Further to simulating the triangular cross-section, we can interrogate the results to identify which combination of x, y, z produces the best result. Demands at each destination may be highly asymmetric. Hence, it is insufficient to simply determine which combination of x, y, z has satisfied the most demand, but, rather a determination is made of which combination of x, y, z has satisfied demand across the destinations fairly i.e., the proportion satisfied at each destination is most similar.

Due to the stochastic nature of the simulation environment (reflecting the reality of the system being modelled), variations may occur that impact the result of any individual simulation. Of course, this could be mitigated be repeating each simulation several times and observing an average. However, this is not necessary in a preferred embodiment of the method. For neighbouring points in the triangular cross-section x+y+z=1, the variation in x, y, z is small therefore it is reasonable to assume the variation in the resultant timetable will be small. Hence, when the results are observed it is not necessary to look for one individual x, y, z case that performs the best. Instead, a percentile is identified (say fifth) of best performing x, y, z combinations in terms of both demands satisfied and fairness, which typically clusters in a similar area of the triangular cross-section and, in turn, identify the average x, y, z value.

The x, y, z weighting values identified represent the best values to use in (4) and generate a timetable for the next period given the current demands. The method with an example will be further explained in the following

### 2. Example Simulation, Results and Analysis

### Example Simulation Scenario

An example network is simulated of approximately 180 nodes and a similar number of links with approximately 55 train agents in operation for a 2 day period. The network structure consists of a double track main corridor with branches to the various destinations (similar to the structure of the simple example shown in FIG. 7, but much larger). There are 2 unloading terminals and 12 loading terminals. For the vast majority of nodes and links s=1 or s=2, reflecting sections of single and double track. However, a few major junction nodes have higher capacity (i.e., s=3) and unloading terminals have significantly high capacity (i.e., s=40).

The network covers a vast area. The journey time from unloading terminal to loading terminal ranges from 3.5 to 9 hours. On each occasion that a train agent reaches a terminal, unloading and loading time are drawn from respective uniform distributions; 3.5-4.25 hours and 6-6.75 hours. Hence the cycle time for any train agent (i.e., the time to leave unloading destination, travel to loading destination, load, return to unloading destination, unload) would range from 16.5 to 28.4 hours, before accounting for the impact of network traffic.

Demand \vec{δ} at the loading terminal agents ranges from a requirement for 4 to 16 train agents to visit the destinations over the 2-day period considered, a total of 72 train agents across the loading terminals. The train agent positions are distributed across the network with initial destinations prescribed.

Vectors X, Y, Z are divided into 35 equal increments from 0 to 1, resulting in 35³ (42,875) points across the parameter space [0,1]×[0,1]×[0,1], 561 of which intersect the triangular cross-section where x+y+z=1. Hence, 561 individual simulations are performed, initiating the network from the same starting point. Each simulation is run such that a 2-day timetable is produced. Train agent movements are governed by the eFCFS algorithm and destinations selected by the ‘high score’ method. Note, when train agents are empty, travelling towards a loading terminal agent they select their destination via the ‘high score’ method, this is recalculated at each junction the train agent passes on route. In the present example simulation, the two unloading terminals are geographically very close to each other and have sufficiently high capacity that there is no risk of train agents having to queue to enter. For simplicity, train agents just select a random unloading terminal as their destination when loaded. In other scenarios the port destination (and specific car dumper) may be prescribed. Along with the demand (i.e., \vec{δ}, number of trains required to visit each mine site), port destinations for the trains after visiting the mine site can also be passed as an input to the method. The demand and port destinations may be received from another network planner module. In such an embodiment the combined systems ensure that the desired grade quality and stockpiles are achieved at the port.

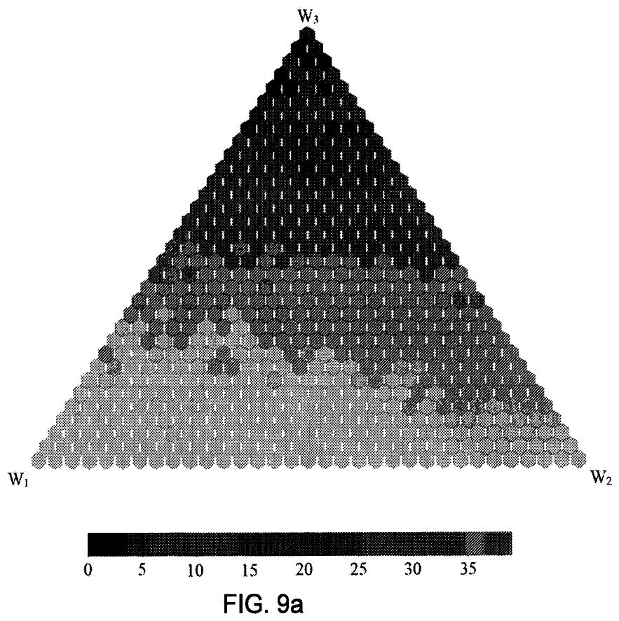

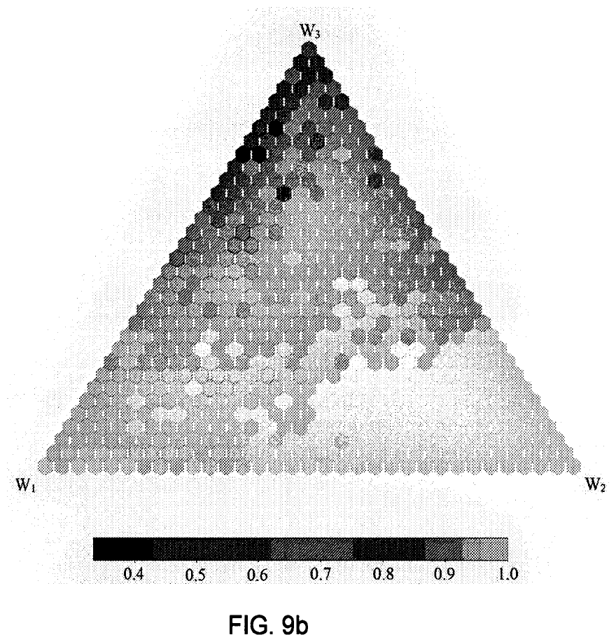

\vec{W₁}, \vec{W₂} and \vec{W₃} are weighted by x, y, z respectively (see (4)). In FIG. 9a there is an incomplete \vec{δ} (i.e., the number of instances the demand was not satisfied). In FIG. 9b there is shown a maximum proportion of incomplete \vec{δ} (i.e., extent to which demand was not satisfied) for any destination.

For each individual simulation the only variation is the values of x, y, and z. The x, y, z values for the 561 individual simulations correspond to the points distributed across the area x+y+z=1 shown in FIG. 8b.

### Results

For each individual simulation, the number of train agents that visited each destination is recorded and hence the incomplete \vec{δ} at each destination is calculated. The proportion \vec{δ} incomplete at each site is also calculated.

FIG. 9a plots the resulting incomplete target demands for each corresponding combination of x, y, z across the triangular section. For the same set of results, FIG. 9b indicates the highest proportion of incomplete demands for any one of the 12 loading terminals agents.

In the example scenario, for every simulation there is at least one destination where \vec{δ} is not completely satisfied i.e., the total number of required train agents did not reach that destination. This indicates that given the initial starting state of the network, it was infeasible to satisfy \vec{δ} across all destinations. Even when presented with demands infeasible to satisfy, the methodology will identify the best possible solution.

The fifth percentile of best results in each plot are identified, i.e., the lowest number of incomplete targets and the lowest proportion of incomplete targets at any unloading terminal, and their corresponding x, y, z coordinates. From this subset, the average x, y, z coordinates can be identified. Here, those values are 0.15, 0.21 and 0.64 respectively. (Of course, this is the specific result for the simulated scenario. For a different initial snapshot, demand at mine sites and with other changes on the network such as shuts (i.e., closed sections of track due to maintenance), these values may be very different.) A train movement graph can be plotted showing the movements of trains across the network such that \vec{δ} is satisfied.

It can be observed from FIG. 9b that weighting the destination selection calculation heavily favouring \vec{W₁}, i.e., selecting destinations based on \vec{δ}, does not perform well. In the bottom left corner of the triangle, corresponding to an increased weighting of \vec{W₁} (i.e., x>y and x>z in (4)), there is a cluster of points with a high number of incomplete demands. \vec{W₁} ranks destinations based on the required number of train agents over the period considered. If selecting destinations via this one metric, all train agents would be directed to the highest requirement destination until that reduced below the second highest. In practice, this is a poor strategy. Loading terminals have a limited capacity. If \vec{δ} is highly asymmetric as our example, this will result in many train agents being directed to a small number of destinations and queuing while waiting to be loaded. It will further negatively impact traffic flow on the network around the terminal, potentially slowing train agents leaving.

A cluster of high values can be seen in FIG. 9b in the bottom right corner corresponding to an increased weighting of \vec{W₂} (i.e., y>x and y>z) in (4). Weighing in favour of \vec{W₂} avoids sending train agents into parts of the network with high traffic. Although weighing heavily in favour of this metric may result in smooth traffic flow, this will not ensure δ at each destination is met. In fact, in this plot, values of 1 can be seen, which indicates zero train agents visited some destinations in the corresponding simulation.

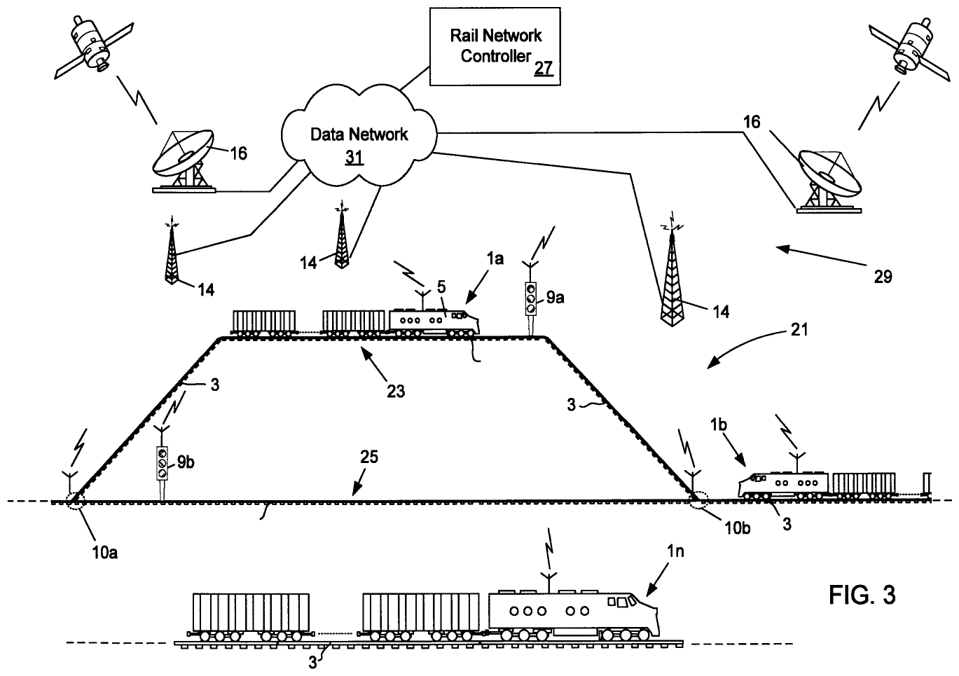

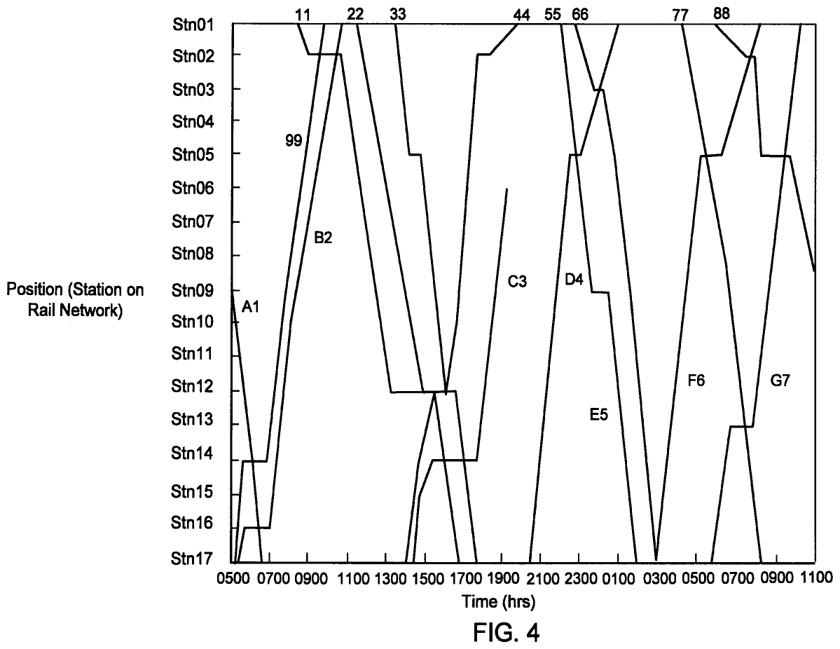

In the example scenario that has been discussed, the best performing simulations in terms of lowest incomplete δ are clustered towards the top of the triangle in FIG. 3b, where there is an increased weighting towards \vec{W₃} (the metric that avoids sending train agents towards terminal queues). The cluster is shifted away from the vertex in FIG. 9b. The combination of these results indicates that avoiding train agent queuing altogether is infeasible when the goal is to fairly satisfy δ across all terminals. However, the optimal ratio of the weightings x, y, z (0.15, 0.21 and 0.64 respectively) indicates that it is advantageous to consider this metric ahead of the other two for identifying optimal destinations.

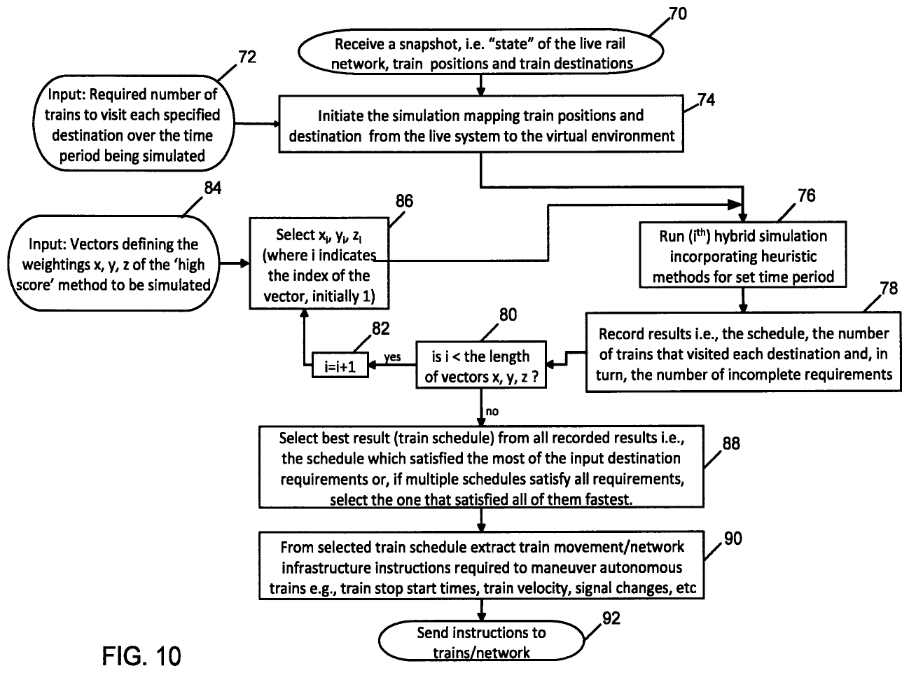

FIG. 10 is a flowchart of the method that is implemented by timetabling machine 33 as configured by the Rail Traffic Timetabling Software 40.

Initially at box 70 the timetabling machine 33 receives a snapshot, i.e., one of the state reports xₜ₁, . . . , xₜₘ (FIG. 6) in respect of the rail network 21 via the data network 31 of data communications system 29.

The snapshot of the rail network 21 indicates the positions of the trains in the network i.e., which nodes/links they currently occupy. From the rail network's topology matrices E and F are constructed (eq 6). These binary matrices indicate the positions of trains within the network. Matrix E indicates which nodes are occupied by trains and matrix F which links. Similarly, matrix A and matrix B (also eq 6). These matrices indicate the nodes/links a train must travel along to reach each of the feasible destination options. The other variables of eq 6, matrix N and matrix L are again properties of the network and so known values.

Similarly (for eq 7), P, a vector of the minimum travel time based on the shortest path link lengths for a train to reach each destination, and Q, a vector of estimated waiting times a train would queue for until a loading bay became available at the terminal can be calculated from the details in the snapshot. Specifically, for calculating Q, the snapshot may indicate trains are currently in a terminal. The information in the snapshot also indicates the time they arrived in the terminal and hence we can estimate the time they will be ready to depart (i.e., having completed loading/unloading).

At box 72, the demand is received as an input. The demand is the number of, vehicles, e.g. trains to be sent to each site. The demand that is received at box 72 corresponds to the \vec{δ} variable in eq 5,

At box 74 timetabling machine 33 initiates a simulation of the rail network based on the snapshot in the simulation environment 44. In the control loop implemented by boxes 76 to 86 the machine 33 runs i=1, . . . , length vector (x) hybrid simulations.

At box 84 vectors X′, Y′, Z′ defining all weightings x, y, z of the ‘high score’ method to be simulated are input. X′, Y′, Z′ are a subset of X, Y, Z which define the three dimensional area [0,1]×[0,1]×[0,1], where the scalar values of corresponding position within the vectors sum to 1 i.e., xᵢ+yᵢ+zᵢ=1.

At box 76 it runs the ith hybrid simulation. At box 78 the results of the ith simulation are recorded in the form of a timetable that sets out the number of trains that visited each destination and, in turn, the number of incomplete requirements.

The loop continues until, at condition box 80, it is determined that i is less than the length of vectors x, y, z.

At box 88 a selection is made of the best result, i.e., train timetable, from all of the results that have been recorded in the running of the loop (boxes 76, 78, 80, 82, 86). The best result is the timetable which is found to satisfy most of the input destination requirements, or if multiple timetables satisfy all requirements then the best timetable is deemed to be the one that satisfied them all fastest.

At box 90, the train timetable that was selected as best at box 88 is processed to extract train movement and network infrastructure instructions that are required to manoeuvre vehicles such as trains, including autonomous trains, over the network. The instructions or “controls” include train velocities, signal changes etc and are issued, at box 92, by machine 33 in a series of electronic timetables S₁, . . . , Sₘ (FIG. 6) across the data communications system 29 to the rail network 21.

### 3. Discussion

### Destination Planning

A method will now be discussed for selecting destinations for a fleet of trains operating on a mining freight rail network. The outcome of the methodology is a feasible timetable and set of destinations to be visited by each train, that best satisfies \vec{δ} for a fleet of trains governed by eFCFS. This could potentially be further optimised via mathematical techniques to produce an operational timetable with highly efficient traffic flow.

Identifying optimal destinations, from the many possible options, for a train fleet is computationally challenging. A full enumeration of all options would not be feasible. The model proposed is computationally light and the method presented significantly reduces the parameter space making the problem computationally tractable. Depending on the complexity of the network and size of the fleet the number of points across the area x+y+z=1 (561 in our example) may be adjusted, which would impact computation time.

The weightings of x, y, z identified as best in the present case study are 0.15, 0.21 and 0.64 respectively i.e., when the weighting of \vec{W₃} is roughly three times that of the other two metrics. This does not mean \vec{W₁} and \vec{W₂} are insignificant. In the large network example with more than 50 trains, there will be numerous cases where the calculation for \vec{W₃} returns the same value for multiple destinations, hence, the decision will ultimately fall to the outcome of \vec{W₁} and \vec{W₂}. The best weighting of x, y, z for operations may change significantly in a different network topology or under different \vec{δ}. The results that are presented are heuristically calculated and not necessarily a true optimal, but, in a complex operation with significant uncertainty adhering to a truly optimal plan is likely infeasible.

The heuristics that have been presented are suitable for the scenario that has been described. The eFCFS could be substituted for an alternate heuristic and the underlying metrics of the ‘high score’ method could be modified or substituted. An example of freight rail networks has been presented, however, it is envisaged that a similar methodology could be employed to benefit the planning process in other forms of logistics and transport.

To recap, a method has been provided for operating a transport network, for example a rail freight network. The network is comprised of a plurality of nodes, e.g. stations and terminals, interconnected by a number of links, e.g. blocks of track, and including vehicles such as trains that are located on the links and nodes. The vehicles are configured for transporting loads between nodes of the transport network.

The method involves establishing communications with vehicles and network control apparatus of the transport network over a data communications network. For example, the method may involve operating a timetabling machine that includes a data communications port and one or more electronic processors that are configured by instructions stored in electronic memory to operate the data communications port to establish the communications.

Once the communications have been established, the method includes receiving a state report (or “snapshot”) of the transport network including positions of the vehicles and states of the network control apparatuses via the data communications network. A plurality of computer simulations, (i.e., an “ensemble” of computer simulations) of the transport network are run with reference to the state report. The computer simulations involve vehicle agents, which are simulations of the vehicles, for example trains, preferably running over a graph that simulates a topology of the transport network.

Typically, the state report is used to set up an initial state for each of the simulations. The computer simulations generate a number of feasible timetables and subsequently one of the feasible timetables is selected as an optimal feasible timetable based on how well it satisfies demands at places, such as terminals, of the network.

Each of the plurality of computer simulations involves a number of actions. The actions include moving vehicle agents corresponding to the vehicles over a graph of the transport network according to a vehicle movement procedure that is configured to avoid gridlocking. In one embodiment an extended First Come First Serve heuristic is used as the vehicle movement procedure but other anti-gridlocking methods may also be used.

The computer simulations are also run according to an optimal destination selection method which is configured to optimise vehicle agent journeys to meet demand for the loads at locations in the transport network. For example, different terminals, such as ports for transporting the loads offshore, may have different demands for loads transported by the vehicles across the transport network at different times. Each of the plurality of computer simulations is made with varied weightings in respect of optimisation factors in the optimal destination selection method to thereby vary each of the number of feasible timetables. The method includes identifying an optimal timetable from the number of feasible timetables and issuing controls to the vehicles and network control apparatus via the data communications network to control movement of the vehicles across the transport network in accordance with the optimal timetable.

### APPENDIX

### First-Come First-Serve

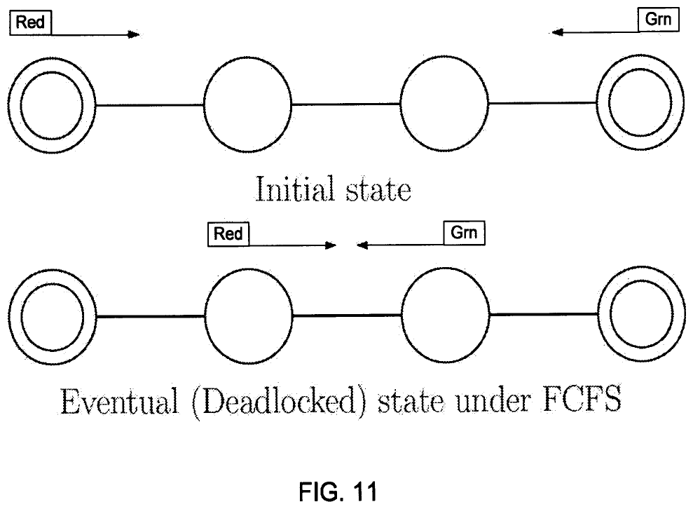

This scheduling policy is a first-in-first-out based scheme. Under FCFS, trains are scheduled to transit a block in the same order they arrive at the block (see Algorithm 1 below). Schedules generated by the verbatim application of this policy are note guaranteed to be feasible, which is evident if you consider FIG. 11. In FIG. 15, trains transit into the next node in their route the moment they arrive eventually leading to a deadlock which can only be resolved through the reversal of at least one train.

Algorithm 1 First-Come-First-Serve (FCFS)

| Input: Trains T which use a common block B | |
|---|---|
| Output: Order which trains in T transit B under FCFS | |
| 1: | L←Sort all trains in T by their arrival time at B |
| 2: | Return L |

### Slot Assignment

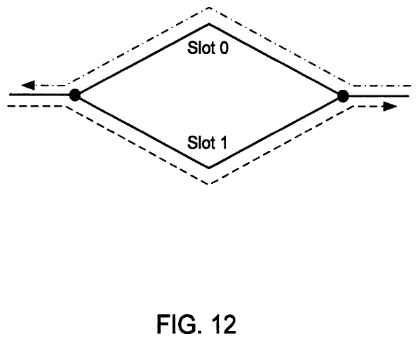

Trains are assigned to slots on the basis of their travel direction over a node, so that trains travelling in one direction are assigned to slot 0 and trains travelling in the opposite direction are assigned to slot 1 (FIG. 12). This means that trains can't overtake other trains through these slots, as this would require trains travelling in the same direction be assigned slots 0 and 1 which is prohibited. Any additional slots beyond the 2 required for train passing can be used to facilitate overtaking. In Algorithm 2 it's assumed that train travel direction over a node can be inferred by its direction property which is either north or south, so that trains travelling south are guaranteed to be travelling in an opposite direction to trains travelling north over a node.

Algorithm 2 Slot assignment for non-overtaking trains

Input: Train T and a multi-slot node n which it must transit without overtaking
Output: The slot which T must use at n

| | |
|---|---|
| 1. | if n is not a terminal node then |
| 2. | if T is travelling south then |
| 3. | Return slot 0 |
| 4. | else |
| 5. | Return slot 1 |
| 6. | end if |
| 7. | else |
| 8. | s ← any free slot at n |
| 9. | end if |

### Extended First-Come First-Serve

An extension to FCFS is proposed for generating feasible schedules, which will be referred to as extended FCFS (eFCFS). Extended FCFS is the application of FCFS at every transit stage so that trains are assigned to slots following Algorithm 3, where the limits of authority are defined so that trains transit unified edges one at a time, as described by Algorithm 1. In extended FCFS, a train cannot depart from a node until the node it's transiting to is available. This can be described in terms of the concept of limits of authority, where each train has a local limit of authority which includes the node it occupies, and the next edge and node in its route. A train cannot depart from its current node until all nodes and edges in its limit of authority are free of trains.

“Local limit of authority” is defined as a region of concern associated with a train defined in terms of block-sections, which includes the block-section currently occupied by the train and all block-sections up to and including the block-section at the next node it will transit. A train takes ownership over its local limit of authority once it's at the front of all the FIFO (First in First Out) queues for all block-sections in the region, at which point the region is guaranteed to be free of trains (per the extended FCFS heuristic).

Algorithm 3 Local Limit of Authority (LOA) Retrieval

Input: A train t, a block-section B it currently occupies, and the remaining
route beginning at R. (A “block-section” is a discrete section of the transport
network which can facilitate one vehicle at a time. For example, a block section
may be a discrete section of track which can facilitate one train at a time.)
Output: The (desired) local limit of authority for train t

| | |
|---|---|
| 1: | L ← [B] |
| 2: | for c ∈ R, excluding B do |
| 3: | s ← Slot to be traversed by t over c identified with Algorithm 2 |
| 4: | b ← Block-section defined by (c,s) |
| 5: | Append b to L |
| 6: | if c is a node then |
| 7: | Return L |
| 8: | end if |
| 9: | end for |

Algorithm 4 describes a discrete event simulation (DES) implementation of the heuristic, where a priority queue keeps track of the next event to be processed sorted in descending order by the time each event should occur. There are FIFO queues for each block-section, where trains at the front of the queue have ownership over it. Once a train is at the front of each queue for nodes and edges in its current local limit of authority (LOA), it has ownership over its local LOA at which point the region is free of trains. Once a train has ownership over its local LOA, it can progress to the next node. The events in the DES are all the arrival and departure events for every train at each node and edge they transit.

Algorithm 4 Extended FCFS

Input: All trains T and their routes consisting of nodes and edges
Output: A feasible schedule

| | |
|---|---|
| 1: | RQ ← Define FIFO queues for each block section |
| 2: | PQ ← Define a priority-queue of events ordered by time (ascending) |
| 3: | time ← 0 (Current time in the simulation) |
| 4: | E ← Collection of all events added to PQ |
| 5: | for t ∈ T do |
| 6: | Define the local limit of authority (LOA) for t with Algorithm 3 |
| 7: | Add t to the queue (at the front) for the block section t initially occupies |
| 8: | Add an arrival event of t at the block section it initially occupies to P Q |
| 9: | end for |
| 10: | while ∃ a train which hasn't terminated do |
| 11: | e ← dequeue the front event from P Q |
| 12: | Add e to E |
| 13: | st ← time of event e |
| 14: | if e is a node arrival event of train t at a block-section B then |
| 15: | l ← the local LOA for t with Algorithm 3 |
| 16: | for block-section b ∈ l do |
| 17: | enqueue t at each of the block-section queues except for B |
| 18: | end for |
| 19: | if t at front of all queues in l then |
| 20: | enqueue edge arrival event to PQ with time of st |
| 21: | end if |
| 22: | if t is a terminal then |
| 23: | Terminate train t |
| 24: | end if |
| 25: | else if e is an edge arrival event of train t at block-section B then |
| 26: | l ← the local LOA for t, excluding B |
| 27: | if t at front of all queues in l then |
| 28: | enqueue edge departure event to PQ with time st + transittime |
| | (transittime is the transit time over B) |
| 29: | if t currently occupies node n then |
| 30: | enqueue departure event of t from n with time st |
| 31: | end if |
| 32: | end if |
| 33: | else if e is an edge departure event of train t from block-section B then |
| 34: | dequeue t from queue for B |
| 35: | Remove B from the LOA of t |
| 36: | enqueue arrival event of t at next node in the LOA of t |
| 37: | else if e is a node departure event of train t from block-section B then |
| 38: | Dequeue t from the queue for B |
| 39: | Remove B from the LOA of t |
| 40: | end if |
| 41: | end while |
| 42: | Return E |

### Feasibility Guarantee (3.7)

### Theorem 1. Extended FCFS Will Always Produce Feasible Schedules.

### Proof.

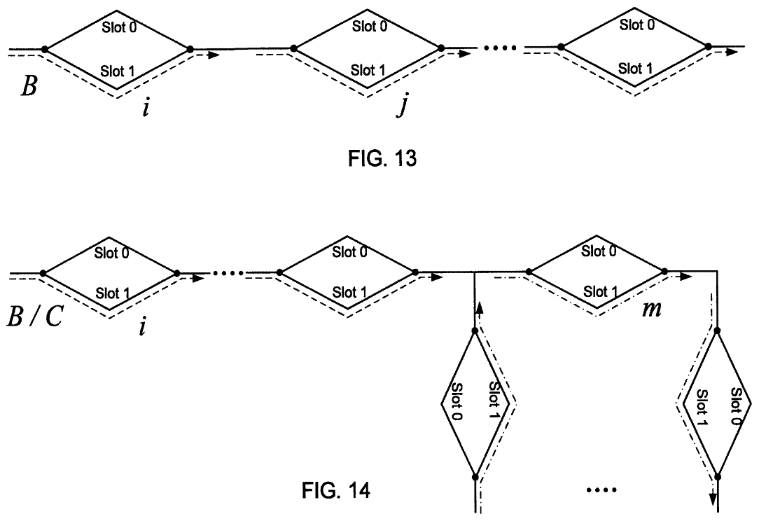

Allow all trains which are not blocked to move forward to their next node, in accordance with FCFS.
Consider a train Tᵢ which is blocked by train Tⱼ. Since trains can only stop at nodes and trains treat unified edges as single edges, we can be sure that Tᵢ and Tⱼ occupy multi-slot nodes past the initialisation phase.
Let B=[Tᵢ, Tⱼ, Tₖ, . . . ] be a list of all trains in this queue spanning any number of nodes as depicted in FIG. 13, where the train at index i∈[2, |B|] blocks the train at index i−1. Clearly, all trains i<k cannot move until the train at k has moved where 2≤k≤|B|.
As trains are assigned to slots based on their travel direction over each node, we can infer Tᵢ and Tⱼ must be travelling in the same direction as they use the same slot at the node currently occupied by Tⱼ.
By induction, all trains in B must be travelling in the same direction.
Either B contains a cycle C=[Tₘ, . . . , Tₘ](case 2, depicted in FIG. 13), or it does not (case 1, depicted in FIG. 14).
Case 1: Under FCFS, all trains will move forward in B. This is possible as they're all travelling in the same direction.
Case 2: Under FCFS, all trains in C will move forward until the cycle vanishes followed by all remaining trains in B-C.
At each stage, at least one train must move forward by one block so eventually all trains must reach their destinations.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described herein comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms. The Abstract of the invention as lodged with this specification is hereby incorporated herein by reference.

Features, integers, characteristics, moieties or groups described in conjunction with a particular aspect, embodiment or example of the invention are to be understood to be applicable to any other aspect, embodiment or example described herein unless incompatible therewith.

Any embodiment of the invention is meant to be illustrative only and is not meant to be limiting to the invention. Therefore, it should be appreciated that various other changes and modifications can be made to any embodiment described without departing from the scope of the invention.

1. A method for operating a transport network comprised of a plurality of nodes interconnected by a number of links and including vehicles located on the links and nodes, the vehicles being for transporting loads between nodes of the transport network, the method comprising:
establishing communications with vehicles and network control apparatus of the transport network over a data communications network;
subsequent to establishing the communications, receiving a state of the transport network including positions of the vehicles and states of the network control apparatuses via the data communications network;
running a plurality of computer simulations of the transport network with reference to the state report for generating a number of feasible timetables, each of the plurality of computer simulations comprising:
moving vehicle agents corresponding to the vehicles over a graph of the transport network according to a vehicle movement procedure configured to avoid gridlocking, and according to an optimal destination selection method configured to optimise vehicle agent journeys to meet demand for the loads at locations in the transport network,
wherein each of the plurality of computer simulations is made with varied weightings in respect of optimisation factors in the optimal destination selection method to thereby vary each of the number of feasible timetables;
identifying an optimal timetable from the number of feasible timetables; and
issuing controls to the vehicles and network control apparatus via the data communications network to control movement of the vehicles across the transport network in accordance with the optimal timetable.

2. The method of claim 1, including determining a set of constraints bounding each of the vehicle agents based on the graph.

3. The method of claim 1, wherein the state report indicates the positions of the vehicles on the nodes and links of the transport network at a current time.

4. The method of claim 1, wherein the vehicle movement procedure includes:
determining values in a current status data structure assembly stored in an electronic data storage assembly.

5. The method of claim 4, wherein the current status data structure assembly stores:
node-vehicle-occupancy_reservation data (matrix E), link-vehicle-occupancy_reservation data (matrix F), node-vehicle-direction data (matrix C), link-vehicle-direction data (matrix D).

6. The method of claim 5, wherein the graph includes slots defining vehicle hosting capacities of the nodes and the links including one or more passing places for vehicles to pass each other.

7. The method of claim 6, wherein running each of the plurality of computer simulations includes associating vehicle journey information, including a destination, with a corresponding vehicle agent.

8. The method of claim 7, wherein the vehicle movement procedure includes:
for each vehicle agent waiting at one of the passing places in the graph
setting a next vehicle agent to be a current vehicle agent,
making a copy of the current status data structure assembly for the current vehicle agent;
updating the copy of the current status data structure assembly to incorporate reservations of nodes and links necessary for the current vehicle agent to proceed on a next leg of a journey defined in the vehicle agent's vehicle journey information to thereby form an updated vehicle-specific status data structure assembly.

9. The method of claim 8, wherein the vehicle movement procedure includes:
for each vehicle agent, testing the updated vehicle-specific status data structure assembly to ensure that vehicle agents' movements comply with a set of constraints bounding individual vehicle agents based on the graph.

10. The method of claim 9, wherein the vehicle movement procedure includes:
upon the updated vehicle-specific status data structure assembly passing the testing, setting the current status data structure assembly to equal the updated vehicle-specific status data structure assembly and issuing a move instruction to the vehicle corresponding to the current vehicle agent.

11. The method of claim 6 including, upon a vehicle agent reaching its destination, assigning it a new destination.

12. The method of claim 11, including successively setting each vehicle agent waiting at one of the passing places in the graph to be a current vehicle agent until all vehicle agents have reached their destination.

13. The method of claim 10, wherein observing interactions of vehicle agents within constraints of the graph model to derive a feasible timetable for the vehicles therefrom includes producing the feasible timetables based on each of the move instructions issued to the vehicle agents.

14. The method of claim 13, wherein the issuing the controls to the vehicles and network control apparatus to control movement of the vehicles across the transport network in accordance with the feasible timetable specifies movements for all vehicles without risk of gridlocking.

15. The method of claim 14, wherein the vehicle movement procedure comprises an extended First Come First Served (eFCFS) heuristic that requires vehicle agents to reserve links up to a next available passing point before proceeding.

16. The method of claim 15, wherein assigning of a new destination to a vehicle agent is made using a high score methodology.

17. The method of claim 16, wherein the high score methodology generates a total score vector.

18. The method of claim 17, including specifying a demand quantity at each destination over a forthcoming time period.

19. The method of claim 18, wherein the demand quantity at each destination over the forthcoming time period comprises a demand vector (\vec{δ}).

20-51. (canceled)

52. A timetabling machine arranged operate a transport network comprised of a plurality of nodes interconnected by a number of links and including vehicles located on the links and nodes, the vehicles being for transporting loads between nodes of the transport network, the timetabling machine comprising:
a data communications port configured to establish communications with vehicles and network control apparatus of the transport network over a data communications network;
one or more electronic processors configured by instructions stored in an electronic memory accessible to said electronic processors, the instructions including:
instructions to receive a state report (or “snapshot”) of the transport network including positions of the vehicles and states of the network control apparatuses via the data communications port;
instructions configuring the one or more processors to run a plurality of computer simulations of the transport network with reference to the state report to thereby generate a number of feasible timetables, including
instructions for the one or more electronic processors to move vehicle agents corresponding to the vehicles over a graph of the transport network, stored in an electronic data storage assembly, according to a vehicle movement procedure configured to avoid gridlocking, and according to an optimal destination selection method configured to optimise vehicle agent journeys to meet demand for the loads at locations in the transport network,
wherein instructions configuring the one or more processors to run a plurality of computer simulations include instructions configuring the one or more processors to run each of the plurality of computer simulations with varied weightings in respect of optimisation factors in the optimal destination selection method to thereby vary each of the number of feasible timetables;
instructions configuring the one or more electronic processors to identify an optimal timetable from the number of feasible timetables; and
instructions configuring the one or more electronic processors to operate the data communications port to issue controls to the vehicles and network control apparatus via the data communications network to control movement of the vehicles across the transport network in accordance with the optimal timetable.
